(19) United States
(12) Patent Application Publication
(10) Pub. No.: US 2017/0292470 A1
(43) Pub. Date: Oct. 12, 2017

(54) INTERNAL COMBUSTION ENGINE

(71) Applicant: TOYOTA JIDOSHA KABUSHIKI KAISHA, Toyota-shi (JP)

(72) Inventors: Taizo YOSHINAGA, Susono-shi (JP); Takeo YAMAGUCHI, Susono-shi (JP); Hideo YAMASHITA, Mishima-shi (JP)

(73) Assignee: TOYOTA JIDOSHA KABUSHIKI KAISHA, Toyota-shi (JP)

(21) Appl. No.: 15/428,396

(22) Filed: Feb. 9, 2017

(30) Foreign Application Priority Data
Apr. 8, 2016 (JP) 2016-078481

(51) Int. Cl. F02F 1/00; C22C 30/02; C23C 4/08; F02F 7/00; C23C 4/129

(52) U.S. Cl. CPC F02F 1/004; F02F 7/0085; C23C 4/129; C23C 4/08; C22C 30/02

(57) ABSTRACT

An internal combustion engine comprising: a combustion chamber surrounded by at least an inner wall of a cylinder bore, a cylinder head, a valve and a piston, and a coating layer arranged on at least part of the inner wall of the combustion chamber, wherein the thermal conductivity of the coating layer is, at room temperature, lower than the thermal conductivities of the cylinder block, the cylinder head, the valve and the piston, the thermal conductivity of the coating layer is reversibly increased along with a rise in the temperature of the coating layer, and wherein the heat capacity per unit area of the coating layer is more than 0 kJ/(m²·K) and 4.2 kJ/(m²·K) or less.

### TECHNICAL FIELD

The present invention relates to an internal combustion engine. More specifically, the present invention relates to an internal combustion engine where a coating layer is arranged on at least part of an inner wall of a combustion chamber.

### BACKGROUND ART

In an internal combustion engine and accessories of the internal combustion engine, efforts are being made to solve various problems by controlling thermal conduction.

For example, Patent Document 1 discloses an approach to prevent dew condensation and overheating of a fuel injection device by using a material having variable thermal conductivity.

With respect to the internal combustion engine, accompanying an increase in the output power thereof, it becomes more important to reduce the cooling loss of an internal combustion engine during operation. As one approach to reduce the cooling loss, an internal combustion engine having a ceramic material-made coating layer arranged on an inner wall of a combustion chamber thereof is disclosed.

For example, Patent Document 2 discloses an internal combustion engine having an alumite film arranged on an inner wall of a combustion chamber thereof and a sealing layer further arranged on a surface of the alumite film. It is also disclosed that the sealing film contains, in addition to a sealing material, a material having a higher emissivity than the sealing material.

In the internal combustion engine disclosed in Patent Document 2, the temperature difference between the mixed gas temperature and the inner wall temperature of the combustion chamber is reduced by the alumite film and the sealing layer and the cooling loss is thereby decreased.

### CITATION LIST

### Patent Document

[Patent Document 1] Japanese Unexamined Patent Publication No. 2014-222035

[Patent Document 2] Japanese Unexamined Patent Publication No. 2015-224362

### SUMMARY OF THE INVENTION

### Problems to be Solved by the Invention

The alumite film has a low thermal conductivity and functions as a heat insulating layer, because the main component is alumina (Al₂O₃). In addition, the sealing layer seals the holes present in the alumina film, and the function of the alumina film as a heat-insulating layer is thereby more enhanced. Furthermore, since the sealing layer contains a material having a high emissivity, radiant heat is imparted to a mixed gas in the combustion chamber, and therefore the function of the alumina film as a heat-insulating layer is more enhanced. When such a heat-insulating layer is arranged on an inner wall of the combustion chamber, the inner wall of the combustion chamber is kept warm, so that the cooling loss of the internal combustion engine can be decreased.

On the other hand, the present inventors have found that in general, when a material having a low thermal conductivity is used as a heat-insulating layer, the internal combustion engine continues to stay in a state of the heat-insulating layer temperature being high for a while even after the completion of combustion of a mixed gas as a result, the intake efficiency is easily deteriorated and knocking easily occur.

The present invention has been made to solve the above-described problems. More specifically, an object of the present invention is to provide an internal combustion engine capable of achieving, at high levels, all of decrease in the cooling loss, suppression of deterioration in the intake efficiency, and inhibition of occurrence of knocking.

### Means to Solve the Problems

The present inventors have made many intensive studies to attain the above-object and accomplished the present invention. The gist of the present invention is as follows.

<1> An internal combustion engine comprising:

a cylinder block,

a cylinder head arranged on one end side of a cylinder bore of the cylinder block,

a valve arranged in the cylinder head,

a piston arranged in the cylinder bore,

a combustion chamber surrounded by at least an inner wall of the cylinder bore, the cylinder head, the valve and the piston, and

a coating layer arranged on at least part of the inner wall of the combustion chamber,

wherein the thermal conductivity of the coating layer is, at room temperature, lower than the thermal conductivities of the cylinder block, the cylinder head, the valve and the piston,

wherein the thermal conductivity of the coating layer is reversibly increased along with a rise in the temperature of the coating layer, and

wherein the heat capacity per unit area of the coating layer is more than 0 kJ/(m²·K) and 4.2 kJ/(m²·K) or less.

<2> The internal combustion engine according to item <1>, wherein the coating layer comprises an alloy having at least partially a quasicrystalline structure.

<3> The internal combustion engine according to item <2>, wherein the alloy having at least partially a quasicrystalline structure is an Al—Cu—Fe-based alloy.

<4> The internal combustion engine according to item <3>, wherein the Al—Cu—Fe-based alloy contains from 20 to 28 atom % of Cu and from 10 to 14 atom % of Fe, and a balance of Al and unavoidable impurities.

<5> The internal combustion engine according to any one of items <1> to <4>, wherein at least any one of the cylinder block, the cylinder head and the piston is made of an aluminum alloy.

### Effects of the Invention

According to the present invention, an internal combustion engine capable of achieving, at high levels, all of decrease in the cooling loss, suppression of deterioration in the intake efficiency, and inhibition of occurrence of knocking can be provided.

### BRIEF DESCRIPTION OF THE DRAWINGS

FIG. 1 A longitudinal cross-sectional view illustrating one example of the neighborhood of the combustion chamber of the internal combustion engine according to the present invention.

FIG. 2 A graph illustrating the relationship between the crank angle (ATDC) and T_{g} or T_{w} with respect to the heat capacity per unit area of the coating layer.

FIG. 3 A graph illustrating the relationship between the heat capacity per unit area of the coating layer and the percentage improvement in BSFC (%).

### MODE FOR CARRYING OUT THE INVENTION

The embodiment of the internal combustion engine according to the present invention is described in detail below. However, the present invention is not limited to the following embodiment.

The combustion chamber of the internal combustion engine is a space surrounded by an inner wall of a cylinder bore, a cylinder head, a valve, a piston, etc. When the difference between the surface temperature of the inner wall of this space (hereinafter, sometimes referred to as “surface temperature of the inner wall of the combustion chamber”) and the temperature of a mixed gas (hereinafter, sometimes referred to as “mixed gas temperature”) in the combustion chamber is small, the cooling loss decreases, and the fuel efficiency of the internal combustion engine increases. The relationship between the cooling loss and the fuel efficiency of the internal combustion engine is described below.

The cooling loss is taken into account mainly after a mixed gas in the combustion chamber starts burning until the surface temperature of the inner wall of the combustion chamber becomes maximum. The cooling loss is represented by the following formula (1). In formula (1), Q_{c} is a cooling loss, h_{gw} is a heat transfer rate between the mixed gas and the inner wall of the combustion chamber, A is a surface area of the inner wall of the combustion chamber, T_{g} is a mixed gas temperature, and T_{w} is a surface temperature of the inner wall of the combustion chamber.

In formula (1), in the case where a coating layer is arranged on the inner wall of the combustion chamber, h_{gw} is a heat transfer rate between the mixed gas and the coating layer, A is a surface area of the coating layer, and T_{w} is a surface temperature of the coating layer.

Q_{c}=∫oh_{gw}·A·(T_{g}−T_{w}) (1)

The fuel efficiency of the internal combustion engine is inversely proportional to the cooling loss Q_{c}. Accordingly, the cooling loss Q_{c} is improved for improved the fuel efficiency of the internal combustion engine.

h_{gw} of an internal combustion engine having a coating layer and h_{gw} of an internal combustion engine having no coating layer can be regarded as substantially the same, and A of an internal combustion engine having a coating layer and A of an internal combustion engine having no coating layer can also be regarded as substantially the same. Accordingly, in order to improve the cooling loss Q_{c}, it is effective to make (T_{g}−T_{w}) small in formula (1).

Many of materials constituting the combustion chamber are a normal metallic material. The “normal metallic material” means a metallic material except for a metal or alloy having at least partially a quasicrystalline structure. In the following, unless otherwise indicated, the “metallic material” means a normal metallic material. The thermal conductivity of the metallic material is high in general. Accordingly, in the case of an internal combustion engine having no coating layer, the thermal conductivity of the inner wall of the combustion chamber is high. If the thermal conductivity of the inner wall of the combustion chamber is high, when a mixed gas in the combustion chamber starts burning, the combustion heat of the mixed gas is easily deprived of by a material constituting the combustion chamber, making it difficult for T_{w} to rise, as a result, (T_{g}−T_{w}) becomes large and in turn, the cooling loss Q_{c} becomes large.

In order to improve the cooling loss Q_{c}, in a conventional internal combustion engine, a ceramic material-made coating layer is sometimes arranged on a surface of the combustion chamber. The thermal conductivity of a ceramic material is generally lower than the thermal conductivity of a metallic material. In the case where the thermal conductivity of the coating layer is low, when the mixed gas in the combustion chamber starts burning, heat can be hardly transferred in the coating layer from the combustion chamber side toward the side opposite the combustion chamber, allowing heat to easily accumulate on the surface of the combustion chamber side of the coating layer. Consequently, T_{w} easily rise and (T_{g}−T_{w}) becomes small, as a result, the cooling loss Q_{c} becomes small.

On the other hand, due to the low thermal conductivity of the coating layer, elevated T_{w} can hardly drop and at the time of introduction (intake) of air into the combustion chamber, the air receives heat from the surface of the coating layer. Accordingly, the intake efficiency is reduced, and knocking easily occur, resulting in low fuel efficiency.

In order to enhance the fuel efficiency by achieving all of decrease in the cooling loss Q_{c}, suppression of reduction in the intake efficiency and inhibition of occurrence of knocking, it may be considered to arrange, on the inner wall of the combustion chamber, a coating layer formed of a material of which thermal conductivity is reversibly increased along with a rise in the temperature. More specifically, it may be considered to arrange, on the inner wall of the combustion chamber, a coating layer formed of a material of which thermal conductivity is reversibly increased along with a rise of T_{w}. Such a material includes a quasicrystalline alloy, a metallic glass, etc. The quasicrystal indicates a material structure that is neither amorphous nor crystalline. In other words, the quasicrystal indicates a material structure that has a long-range order but does have translation symmetry.

However, the present inventors have found that only when a coating layer formed of such a material is arranged on the inner wall of the combustion chamber and the thermal conductivity of the coating layer is changed, it is impossible to achieve all of decrease in the cooling loss Q_{c}, suppression of reduction in the intake efficiency, and inhibition of occurrence of knocking. The present inventors have found that in addition to a change in the thermal conductivity of the coating layer, when the heat capacity per unit area of the coating layer is in a predetermined range, all of decrease in the cooling loss Q_{c}, suppression of reduction in the intake efficiency, and inhibition of occurrence of knocking can be achieved.

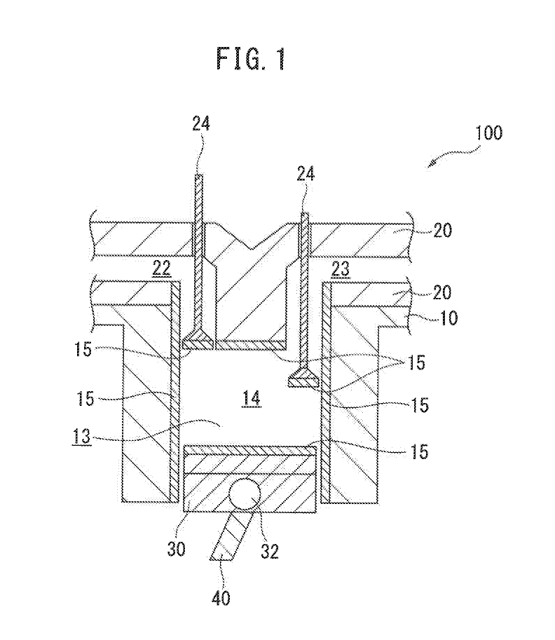

The constituents of the internal combustion engine of the present invention based on these findings is described below. FIG. 1 is a longitudinal cross-sectional view illustrating one example of the neighborhood of the combustion chamber of the internal combustion engine according to the present invention. In the following, the internal combustion engine of the present invention is described with respect to each constituent element.

(Cylinder Block)

The internal combustion engine 100 of the present invention has a cylinder block 10. The cylinder block 10 is generally made of a metallic material. The metallic material includes, for example, flake graphite cast iron, spheroidal graphite cast iron, and an aluminum alloy.

In the cylinder block 10, a cylinder bore 13 is formed. In FIG. 1, one cylinder bore 13 is illustrated, but the number of cylinder bores 13 is not limited. In the case where a plurality of cylinder bores 13 are formed in the cylinder block 10, the structure around an individual cylinder bore 13 is generally the same as in FIG. 1. However, it may be sufficient if the structure around at least one cylinder bore 13 has the constituent elements of the present invention.

Although not illustrated in FIG. 1, a cooling circuit may be provided in the cylinder block 10. In the case where a cooling circuit is provided, the cooling circuit is arranged at a position distant from the cylinder bore 13. The cooling circuit prevents overheating of the cylinder block 10. Consequently, a material not particularly having heat resistance, such as flake graphite cast iron, spheroidal graphite cast iron and aluminum alloy, can be used for the cylinder block 10. On the other hand, if the later-described coating layer 15 is not arranged, T_{w} becomes too low as a result, the cooling loss Q_{c} is increased. From this viewpoint as well, a coating layer 15 is arranged.

(Cylinder Head)

A cylinder head 20 is arranged on one end side of the cylinder bore 13. A crank shaft (not illustrated) is arranged on the other end side of the cylinder bore 13.

The cylinder head 20 is generally made of a metallic material. The metallic material includes, for example, flake graphite cast iron, spheroidal graphite cast iron, and an aluminum alloy.

In the cylinder head 20, an intake passage 22 and an exhaust passage 23 are formed. In FIG. 1, one intake passage 22 and one exhaust passage 23 are illustrated per one cylinder bore 13, but the configuration is not limited thereto. For example, two intake passages 22 and two exhaust passages 23 may be formed per one cylinder bore 13.

Although not illustrated in FIG. 1, a cooling circuit may be provided in the cylinder head 20. In the case where a cooling circuit is provided, the cooling circuit is arranged at a position distant from the intake passage 22 or exhaust passage 23. The cooling circuit prevents overheating of the cylinder head 20. Consequently, a material not particularly having heat resistance, such as flake graphite cast iron, spheroidal graphite cast iron and aluminum alloy, can be used for the cylinder head 20. On the other hand, if the later-described coating layer 15 is not arranged, T_{w} becomes too low as a result, the cooling loss Q_{c} is increased. From this viewpoint as well, a coating layer 15 is arranged.

(Valve)

In the cylinder head 20, a valve 24 is arranged. The valve 24 switches between intake and exhaust of the internal combustion engine 100. As illustrated in FIG. 1, one valve 24 is arranged per one intake passage 22. Similarly, one valve 24 is arranged per one exhaust passage 23.

In the valve 24, a cooling circuit is scarcely provided. Accordingly, in many cases, the valve 24 is made of a heat-resistant material such as titanium alloy. The heat-resistant material is a metallic material and generally has a high thermal conductivity, compared with a ceramic material, etc. Consequently, when the valve 24 surface along a combustion chamber 14 receives heat from a mixed gas, the heat is easily transferred to the side opposite the combustion chamber 14 of the valve 24, and thus the heat can hardly stay at the valve 24 surface on the combustion chamber 14 side, making it difficult for T_{w} to rise in the valve 24, as a result, (T_{g}−T_{w}) does not become small, in other words, the cooling loss Q_{c} is not easily decreased. For this reason, the later-described coating layer 15 is arranged in order to avoid the difficulty of raising T_{w}.

(Piston)

In the cylinder bore 13 of the cylinder block 10, a piston 30 is arranged. The piston 30 slides in the cylinder bore 13 in the axial direction of the cylinder bore 13. In order to prevent the piston 30 from seizing to the inner wall of the cylinder bore 13 due to sliding of the piston 30, a lubricant is injected into the piston 30.

Injection of a lubricant prevents overheating of the piston 30. Accordingly, a material not particularly having heat resistance, such as aluminum alloy, can be used for the piston 30. On the other hand, if the later-described coating layer 15 is not arranged on the surface along the combustion chamber 14, T_{w} becomes too low, as a result, the cooling loss Q_{c} is increased. From this viewpoint as well, a coating layer 15 is arranged.

(Combustion Chamber)

In the internal combustion engine 100, a combustion chamber 14 is formed. The combustion chamber 14 is formed by being surrounded by at least the inner wall of the cylinder bore 13, the cylinder head 20, the valve 24, and the piston 30. The combustion chamber 14 may also be formed by being surrounded by part or the whole of another component, in addition to the inner wall of the cylinder bore 13, the cylinder head 20, the valve 24, and the piston 30. Part or the whole of another component includes, for example, part of a fuel injection device.

The shape of the combustion chamber 14 is not particularly limited and includes, for example, a hemispherical type and a pent-roof type. The fuel injection method is also not particularly limited and includes a direct injection type, an indirect injection type, etc.

(Coating Layer)

A coating layer 15 is arranged on at least part of the inner wall of the combustion chamber 14. In the embodiment illustrated in FIG. 1, a coating layer 15 is arranged throughout the inner wall of the combustion chamber 14. More specifically, the coating layer 15 is arranged on the inner wall of the cylinder bore 13, on the combustion chamber 14 side of the piston 30 (the top surface of the piston 30), and on the combustion chamber 14 sides of the cylinder head 20 and the valve 24. However, the arrangement of the coating layer 15 is not limited thereto.

One example includes, in the embodiment illustrated in FIG. 1, omitting the coating layer 15 arranged on the valve 24. In the valve 24, unlike the cylinder block 10 and the cylinder head 20, a cooling circuit is scarcely provided and even when the arrangement of the coating layer 15 on the valve 24 is omitted, T_{w} may be not lowered excessively, as a result, (T_{g}−T_{w}) may not become large excessively and the cooling loss Q_{c} may be not increased excessively. In such a case, arrangement of the coating layer 15 on the valve 24 can be omitted.

Another example includes, in the embodiment illustrated in FIG. 1, omitting the coating layer 15 arranged on the piston 30. The piston 30 is cooled with a lubricant. However, when a lubricant having a small cooling ability is used, even if the arrangement of the coating layer 15 on the piston 30 is omitted, T_{w} may not be lowered excessively, as a result, (T_{g}−T_{w}) may not become large and the cooling loss Q_{c} may be not increased. In such a case, arrangement of the coating layer 15 on the piston 30 can be omitted.

In the case where the combustion chamber 14 is formed by being surrounded by part or the whole of another component in addition to the inner wall of the cylinder bore 13, the cylinder head 20, the valve 24, and the piston 30, the coating layer 15 may be arranged on part or the whole of another component.

(Thermal Conductivity of Coating Layer)

The thermal conductivity of the coating layer 15 of the internal combustion engine 100 according to the present invention is, at room temperature, lower than the thermal conductivities of the cylinder block 10, the cylinder head 20, the valve 24 and the piston 30, and the thermal conductivity of the coating layer 15 is reversibly increased along with a rise in the temperature of the coating layer 15. As described above, the material having such a thermal conductivity includes a quasicrystalline alloy, metallic zirconium glass, vanadium dioxide, etc. In the quasicrystalline alloy, the whole of the alloy structure thereof need not be a quasicrystalline structure, and it may be sufficient if the alloy has a quasicrystalline structure in at least part of the alloy structure.

As described above, there is a case where the combustion chamber 14 is formed by being surrounded by part or the whole of another component, in addition to the inner wall of the cylinder bore 13, the cylinder head 20, the valve 24, and the piston 30, and the coating layer 15 is arranged on part or the whole of another component. In such a case, the thermal conductivity of the coating layer 15 is, at room temperature, lower than the thermal conductivity in part or the whole of another component, and the thermal conductivity of the coating layer 15 is reversibly increased along with a rise in the temperature of the coating layer 15.

The room temperature indicates 25° C. The rise in the temperature of the coating layer 15 indicates a rise at least to 800° C. The upper limit of the rise in the temperature of the coating layer 15 differs according to the heat resistance of the coating layer 15. The upper limit of the rise in the temperature of the coating layer 15 is preferably 1,000° C., more preferably 1,100° C. When the upper limit of the temperature of the coating layer 15 is not more than the temperature above, the coating layer 15 is not changed in quality and/or the coating layer 15 is not exfoliated from the cylinder block 10, etc.

When the thermal conductivity at room temperature of the coating layer 15 is lower than the thermal conductivities of the cylinder block 10, the cylinder head 20, the valve 24 and the piston 30, at the time of start up of the internal combustion engine 100 at room temperature, the coating layer 15 hardly allows the cylinder block 10, etc. to be deprived of heat. Therefore, T_{w} is prevented from lowering, and (T_{g}−T_{w}) becomes small, as a result, the cooling loss Q_{c} is decreased.

Since the thermal conductivity of the coating layer 15 is increased along with a rise in the temperature of the coating layer 15, the thermal conductivity of the coating layer 15 in the internal combustion engine 100 after the completion of warm-up (hereinafter, sometimes referred to as “internal combustion engine 100 during operation”) is higher than the thermal conductivity of the coating layer 15 at room temperature.

In the internal combustion engine 100 during operation, within one cycle consisting of intake, compression, expansion and exhaust, the temperature of the coating layer 15 is changed at least in the range of 100 to 800° C. Even in this temperature range, the thermal conductivity of the coating layer 15 reversibly increased along with a rise in the temperature of the coating layer 15. That is, in the internal combustion engine 100 during operation, the thermal conductivity of the coating layer 15 is low when T_{w} is low, and the thermal conductivity of the coating layer 15 is high when T_{w} is high.

Inside the coating layer 15 of the internal combustion engine 100 during operation, heat is transferred from the combustion chamber 14 side toward the side opposite to the combustion chamber 14 (the cylinder block 10, etc. side) (hereinafter, the direction in which heat is transferred is sometimes referred to as “heat transfer direction”). The thermal conductivity is a value indicating ease of transfer of heat in the heat transfer direction.

In the internal combustion engine 100 during operation, when a mixed gas in the combustion chamber starts burning, T_{w} is low, and therefore the thermal conductivity of the coating layer 15 is low. Accordingly, heat is not easily transferred in the heat transfer direction inside the coating layer 15, and heat received from the combustion chamber 14 side of the coating layer 15 easily accumulates near the coating layer 15 surface on the combustion chamber 14 side. As a result, T_{w} easily rise, but the rise of T_{w} is affected by the heat capacity per unit area of the coating layer 15, in addition to the thermal conductivity of the coating layer 15.

On the other hand, in the internal combustion engine 100 during operation, when the coating layer 15 receives sufficient heat from a mixed gas, T_{w} is high, and therefore the thermal conductivity of the coating layer 15 is large. Accordingly, heat is easily transferred in the heat transfer direction inside the coating layer 15, and heat received from the combustion chamber 14 side of the coating layer 15 is easily transferred to the side opposite to the combustion chamber 14 (the cylinder block 10, etc. side) of the coating layer 15. As a result, T_{w} easily drop, but the drop of T_{w} is affected by the heat capacity per unit area of the coating layer 15, in addition to the thermal conductivity of the coating layer 15.

(Heat Capacity Per Unit Area of Coating Layer)

In either case where T_{w} rises or drops, T_{w} is affected by the heat capacity per unit area of the coating layer 15. When the heat capacity per unit area of the coating layer 15 is in a predetermined range, all of decrease in the cooling loss Q_{c}, suppression of reduction in the intake efficiency, and inhibition of occurrence of knocking can be achieved at high levels.

The heat capacity per unit area of the coating layer 15 was studied for its appropriate range through CAE (Computer Aided Engineering) analysis. As for the analysis method, an internal combustion engine 100 illustrated in FIG. 1 was finite element modeled and using the model, the mixed gas temperature (T_{g}), the surface temperature (T_{w}) on the combustion chamber 14 side of the coating layer 15, and BSFC were calculated by changing the heat capacity per unit are of the coating layer 15.

BSFC (Brake Specific Fuel Consumption) is defined by the mass of fuel consumed in order to maintain an output power of 1 kW over one hour. BSFC is improved particularly when all of decrease in the cooling loss Q_{c}, suppression of reduction in the intake efficiency, and inhibition of occurrence of knocking can be achieved at high levels.

FIG. 1 is illustrated by exaggerating the thickness of the coating layer 15 so that the presence of the coating layer 15 can be distinguished. However, in practice, the coating layer 15 is very thin relative to the cylinder block 10, the cylinder head 20, the valve 24, and the piston 30, and therefore, at the time of finite element modeling of the internal combustion engine 100, it is difficult to define an element corresponding to the coating layer 15 by reflecting the thinness of the coating layer 15.

The coating layer 15 was therefore defined according to the following procedure after dividing each of the cylinder block 10, the cylinder head 20, the valve 24, the piston 30 and the combustion chamber 14 into elements (mesh division). First, elements at the sites where elements of the cylinder block 10, the cylinder head 20, the valve 24 and the piston 30 adjoin an element of the combustion chamber 14 to each other were extracted. Next, out of the elements extracted, the elements of the cylinder block 10, the cylinder head 20, the valve 24, and the piston 30 were defined as the elements of the coating layer 15.

To the thus-defined elements of the coating layer 15, a thermal conductivity of 1.8 W/(m·K) and a heat capacity per unit area changed in the range of 0.6 to 4.2 kJ/(m²·K) was applied and The analysis was performed by applying, as boundary conditions. The thermal conductivity above corresponds to the thermal conductivity at room temperature of an Al₆₃Cu_{24.5}Fe_{12.5} alloy. The Al₆₃Cu_{24.5}Fe_{12.5} alloy is described later.

At the time of analysis, GTPOWER (registered trademark) of Gamma Technologies, Inc. was used as the software (solver). Due to the software constraint, the analysis cannot be performed by changing the thermal conductivity in one cycle consisting of intake, compression, expansion and exhaust, and therefore the thermal conductivity of the coating layer 15 was set at a constant 1.8 W/(m·K).

On the other hand, analysis was performed on the internal combustion engine not having a coating layer 15 by applying, as boundary conditions, thermal conductivities of the cylinder block 10, etc. and a heat capacity per unit area of 0 kJ/(m²·K) to elements at the sites where elements of the cylinder block 10, etc. adjoin an element of the combustion chamber 14 to each other. The cylinder block 10, etc. indicates the cylinder block 10, the cylinder head 20, the valve 24, and the piston 30.

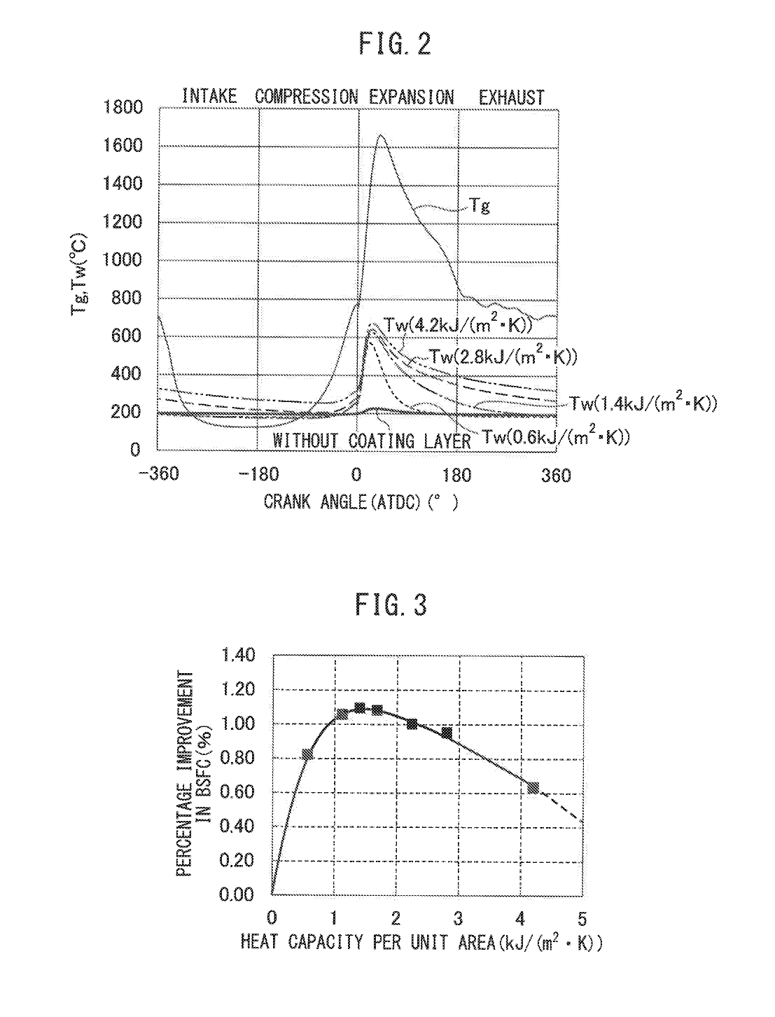

FIGS. 2 and 3 illustrate the analysis results. In addition, the results of FIG. 3 are summarized in Table 1.

TABLE 1

| Heat Capacity Per Unit | Percentage Improvement |
|---|---|
| Area (kJ/m² · K) | in BSFC (%) |
| 0 | 0 |
| 0.6 | 0.82 |
| 1.1 | 1.06 |
| 1.4 | 1.10 |
| 1.7 | 1.08 |
| 2.2 | 1.00 |
| 2.8 | 0.95 |
| 4.2 | 0.63 |

FIG. 2 is a graph illustrating the relationship between the crank angle (ATDC) and T_{g} or T_{w} with respect to the heat capacity per unit area of the coating layer 15. Here, the crank angle (ATDC: After Top Dead Center) is a rotational angle (working angle) of a crankshaft when the top dead center is at 0°. In FIG. 2, when the crank angle is from −360 to −180°, this indicates intake; when the crank angle is from −180 to 0°, this indicates compression; when the crank angle is from 0 to 180°, this indicates expansion; and when the crank angle is from 180 to 360°, this indicates exhaust.

As shown in FIG. 2, with respect to the internal combustion engine not having a coating layer, even when T_{g} is elevated at the time of expansion, the rise in T_{w} is slight, i.e., (T_{g}−T_{w}) is large.

On the other hand, with respect to the internal combustion engine 100 of the present invention, since the coating layer 15 is arranged on the inner wall of the combustion chamber 14, T_{w} follows the rise in T_{g} and (T_{g}−T_{w}) is small.

In FIG. 2, compared with the internal combustion engine not having a coating layer, in the internal combustion engine 100 of the present invention, at the initial stage of expansion, more specifically, when a mixed gas starts burning and T_{g} starts rising, T_{w} sharply rises due to the coating layer 15. The reason is considered as follows. Since the thermal conductivity of the coating layer 15 is as low as 1.8 W/(m·K), in the coating layer 15, heat is not easily transferred from the combustion chamber 14 side to the side opposite to the combustion chamber 14. As a result, heat easily accumulates near the coating layer 15 surface on the combustion chamber 14 side, and T_{w} sharply rises.

The larger the heat capacity per unit area of the coating layer 15 is, the higher the maximum value of T_{w} is. The reason is that the larger the heat capacity per unit area of the coating layer 15 is, the more time it takes for elevated T_{w} to drop and the coating layer 15 further receives heat from the combustion chamber until T_{w} drops.

On the other hand, in FIG. 2, after T_{g} reaches a maximum value, the larger the heat capacity per unit area of the coating layer 15 is, the more time it takes for T_{w} to drop. Therefore, the larger the heat capacity per unit area of the coating layer 15 is, the higher T_{w} during intake is. As a result, when air is introduced into the combustion chamber 14, the air receives heat from the coating layer 15. This lead to deterioration of intake efficiency and occurrence of knocking. In other words, the larger the heat capacity of the coating layer 15 is, the more easily the intake efficiency is deteriorated and the more easily knocking occurs.

FIG. 3 is a graph illustrating the relationship between the heat capacity per unit area of the coating layer 15 and the percentage improvement in BSFC (%). Here, the percentage improvement in BSFC (%) is a ratio (percentage) of the value of improved BSFC of the internal combustion engine 100 having a coating layer 15 to the value of BSFC of the internal combustion engine not having a coating layer 15.

As shown in FIG. 3, as long as the heat capacity per unit area of the coating layer 15 even slightly exceeds 0 kJ/(m²·K), i.e., as long as the coating layer 15 is arranged, BSCF is improved. When the heat capacity per unit area of the coating layer 15 is from 1.0 to 2.0 kJ/(m²·K), the percentage improvement in BSFC becomes maximum. After the percentage improvement in BSFC (%) becomes maximum, the percentage improvement in BSFC (%) decreases along with an increase in the heat capacity per unit area of the coating layer 15.

As described above, due to the low thermal conductivity of the coating layer 15, heat accumulates on the combustion chamber 14 side of the coating layer 15, and T_{w} sharply rises and reaches a maximum value. As a result, (T_{g}−T_{w}) becomes small, and the cooling loss Q_{c} is decreased. In addition, the larger the heat capacity per unit area of the coating layer 15 is, at the time of sharp rise of T_{w}, the more hardly the elevated T_{w} drops, and therefore the maximum value of T_{w} becomes high.

On the other hand, after T_{w} reaches a maximum value, the larger the heat capacity per unit area of the coating layer 15 is, the more hardly T_{w} having reached a maximum value drop. In other words, the larger the heat capacity per unit area of the coating layer 15 is, the higher T_{w} during intake becomes.

In this way, when the heat capacity per unit area of the coating layer 15 is increased, there is produced a conflicting relationship, i.e., the cooling loss Q_{c} is improved but the intake efficiency is deteriorated.

However, as shown in FIG. 3, BSFC is improved (the percentage improvement in BSFC (%) is more than 0%) after the heat capacity per unit area of the coating layer 15 exceeds 0 kJ/(m²·K) until reaching a certain upper limit value. This is considered to occur for the following reason.

Until T_{w} reaches a maximum value, even when the heat capacity per unit area of the coating layer 15 becomes large, the cooling loss Q_{c} is improved to a larger extent than the extent to which the intake efficiency is deteriorated.

On the other hand, after T_{w} starts dropping from the maximum value, as long as the heat capacity per unit area of the coating layer 15 does not become excessively large, the improvement of the cooling loss Q_{c} is not entirely negated by the deterioration of intake efficiency. As shown in FIG. 3, the analysis is performed only until the heat capacity per unit area of the coating layer 15 is increased to 4.2 kJ/(m²·K). Accordingly, the heat capacity per unit area of the coating layer 15, with which the improvement of the cooling loss Q_{c} is entirely negated by the deterioration of intake efficiency, is unknown. However, in FIG. 3, at least when the heat capacity per unit area of the coating layer 15 is more than 0 kJ/(m²·K) and 4.2 kJ/(m²·K) or less, BSFC is improved (the percentage improvement in BSFC (%) exceeds 0%).

In the analysis, the thermal conductivity of the coating layer 15 is set to a constant value of 1.8 W/(m·K). On the other hand, in an actual engine, the thermal conductivity of the coating layer 15 is reversibly increased along with a rise in the temperature of the coating layer 15. Accordingly, the percentage improvement in BSFC (%) shown in FIG. 3 differs from the percentage improvement in BSCF (%) in an actual engine.

However, as long as the heat capacity per unit area of the coating layer 15 even slightly exceeds 0 kJ/(m²·K), i.e., as long as the coating layer 15 is arranged, BSCF is improved, and this is considered to be also true in an actual engine. This is because the thermal conductivity of the coating layer 15 is lower than the thermal conductivities of the cylinder block 10, the cylinder head 20, the valve 24 and the piston 30, and therefore even when the coating layer 15 is very thin, the coating layer 15 functions as a heat insulating layer and contributes to the rise of T_{w}. The case where the coating layer 15 is very thin is a case where the thermal capacity per unit area of the coating layer 15 is very small.

In FIG. 3 (in the analysis), when the thermal capacity per unit area of the coating layer 15 is 0.6 kJ/(m²·K), BSFC is improved, and thus, when the thermal capacity of the coating layer 15 of the internal combustion engine 100 according to the present invention is 0.6 kJ/(m²·K), the effects of the present invention are provided. This is because, as long as the thermal capacity of the coating layer 15 even slightly exceeds 0 kJ/(m²·K), the effects of the present invention are provided.

On the other hand, in FIG. 3 (in the analysis), when the thermal capacity per unit area of the coating layer 15 is 4.2 kJ/(m²·K), BSFC is improved. In the analysis, the thermal conductivity of the coating layer 15 is set to a constant value of 1.8 W/(m·K), whereas in an actual engine, the thermal conductivity of the coating layer 15 is reversibly increased along with a rise in the temperature of the coating layer 15. Then, in an actual engine, the intake efficiency is more improved than in the analysis, to an extent corresponding to an increase in the thermal conductivity of the coating layer 15. Accordingly, the percentage improvement in BSFC in an actual machine is higher than the percentage improvement in BSFC (%) shown in FIG. 3. Consequently, when the thermal capacity of the coating layer 15 of the internal combustion engine 100 according to the present invention is 4.2 kJ/(m²·K), the effects of the present invention are provided.

For these reasons, the thermal capacity per unit area of the coating layer 15 of the internal combustion engine of the present invention is more than 0 kJ/(m²·K) and 4.2 kJ/(m²·K) or less. The lower limit of the heat capacity per unit area of the coating layer 15 may be 0.6 kJ/(m²·K). The upper limit of the heat capacity per unit area of the coating layer 15 may be 2.8 kJ/(m²·K).

(Material of Coating Layer)

The material of the coating layer 15 is not particularly limited as long as the coating layer 15 satisfies the requirements described above. The material of the coating layer 15 includes, as described above, a quasicrystalline alloy, metallic zirconium glass, vanadium dioxide, etc. and a combination thereof. The quasicrystalline alloy comprises at least partially an alloy having a quasicrystalline structure.

Other than a quasicrystalline alloy, metallic zirconium glass and vanadium dioxide, the coating layer 15 may also contain another material as long as the effects of the present invention are not impaired. Another material includes a metallic material, an oxide, a sulfide, a nitride, etc.

The quasicrystalline alloy includes an Al—Cu—Fe-based alloy, an Al—Pd—Re-based alloy, an Al—Pd—Mn-based alloy, etc., with an Al—Cu—Fe-based alloy being representative.

The composition of the Al—Cu—Fe-based alloy is not particularly limited as long as the Al—Cu—Fe-based alloy at least partially has a quasicrystalline structure. The Al—Cu—Fe-based alloy may contain an element other than Al, Cu and Fe for improving specific properties, as long as the effects of the present invention are not impaired. The element includes, for example, Ru, Rh, Pd, Ag, Os, Ir, Pt, and Au.

In view of stability of the quasicrystalline structure, the Al—Cu—Fe-based alloy preferably contains from 20 to 28 atom % of Cu and from 10 to 14 atom % of Fe, and a balance of Al and unavoidable impurities. In this case, when the whole of the Al—Cu—Fe-based alloy is 100 mass %, the content of unavoidable impurities is preferably 3 mass % or less, more preferably 1 mass % or less, still more preferably 0.5 mass %. Such an Al—Cu—Fe-based alloy includes, for example, an Al₆₃Cu_{24.5}Fe_{12.5} alloy. The thermal conductivity of the Al₆₃Cu_{24.5}Fe_{12.5} alloy is 1.8 W/(m·K) at room temperature and 4.5 W/(m·K) at 500° C. The thermal conductivity of the Al₆₃Cu_{24.5}Fe₁₂ alloy is linearly increased between room temperature and 500° C.

The Al—Cu—Fe-based alloy is an alloy mainly composed of Al. Accordingly, when the coating layer 15 is formed of an Al—Cu—Fe-based alloy, the cylinder block 10, the cylinder head 20, and the piston 30 are also preferably formed of an aluminum alloy. By doing so, the coefficient of thermal expansion of the coating layer 15 can be close to that of the cylinder block 10, etc., as a result, the coating layer 15 can be hardly separated. The cylinder block 10, etc. means the cylinder block 10, the cylinder head 20, and the piston 30.

The aluminum alloy used for the cylinder block 10 includes, for example, an aluminum alloy for casting or die-casing. The aluminum alloy for casting or die-casting used for the cylinder block 10 includes, for example, Japanese Industrial Standards (JIS) AC4B, AC4C and AC4D, ADC10, and ADC12.

The aluminum alloy used for the cylinder head 20 includes, for example, an aluminum alloy for casting. The aluminum alloy for casting used for the cylinder head 20 includes, for example, Japanese Industrial Standards (JIS) AC2A, AC2B and AC4B.

The aluminum alloy used for the piston 30 includes, for example, an aluminum alloy for casting. The aluminum alloy for casting used for the piston 30 includes, for example, Japanese Industrial Standards (JIS) AC8A, AC8B and AC8C, AC9A, and AC9B.

(Manufacturing Method of Internal Combustion Engine of the Present Invention)

The manufacturing method of the internal combustion engine 100 of the present invention is the same as the manufacturing method of a normal internal combustion engine 100 except for arranging a coating layer 15 on the inner wall of the combustion chamber 14.

When a coating layer 15 in arranged on the inner wall of the combustion chamber 14, the coating layer 15 is arranged in required portions of the cylinder block 10, the cylinder head 20, the valve 24, and the piston 30 in advance. Thereafter, the cylinder block 10, the cylinder head 20, the valve 24, and the piston 30 are assembled in order to obtain the internal combustion engine 100.

The method for arranging the coating layer 15 is not particularly limited as long as the coating layer 15 can be adhere to the required portions of the cylinder block 10, the cylinder head 20, the valve 24, and the piston 30. The method includes, for example, a method where the raw material of the coating layer 15 is pulverized to a powder and the powder is flame-sprayed to the required portions of the cylinder block 10, the cylinder head 20, the valve 24, and the piston 30.

In the case where the combustion chamber 14 is formed by being surrounded by part or the whole of another component, in addition to the inner wall of the cylinder block 10, the cylinder head 20, the valve 24, and the piston 30, the coating layer is arranged in the same manner on part or the whole of another component.

### DESCRIPTION OF NUMERICAL REFERENCES

10 Cylinder block
13 Cylinder bore
14 Combustion chamber
15 Coating layer
20 Cylinder head
22 Intake passage
23 Exhaust passage
24 Valve
30 Piston
32 Piston pin
40 Connecting rod

What is claimed is:

1. An internal combustion engine comprising:
a cylinder block,
a cylinder head arranged on one end side of a cylinder bore of the cylinder block,
a valve arranged in the cylinder head,
a piston arranged in the cylinder bore,
a combustion chamber surrounded by at least an inner wall of the cylinder bore, the cylinder head, the valve and the piston, and
a coating layer arranged on at least part of the inner wall of the combustion chamber,
wherein the thermal conductivity of the coating layer is, at room temperature, lower than the thermal conductivities of the cylinder block, the cylinder head, the valve and the piston,
wherein the thermal conductivity of the coating layer is reversibly increased along with a rise in the temperature of the coating layer, and
wherein the heat capacity per unit area of the coating layer is more than 0 kJ/(m²·K) and 4.2 kJ/(m²·K) or less.

2. The internal combustion engine according to claim 1, wherein the coating layer comprises an alloy having at least partially a quasicrystalline structure.

3. The internal combustion engine according to claim 2, wherein the alloy having at least partially a quasicrystalline structure is an Al—Cu—Fe-based alloy.

4. The internal combustion engine according to claim 3, wherein the Al—Cu—Fe-based alloy contains from 20 to 28 atom % of Cu and from 10 to 14 atom % of Fe, and a balance of Al and unavoidable impurities.

5. The internal combustion engine according to claim 1, wherein at least any one of the cylinder block, the cylinder head and the piston is made of an aluminum alloy.
